(19) United States
(12) Patent Application Publication
(10) Pub. No.: US 2020/0116882 A1
(43) Pub. Date: Apr. 16, 2020

(54) METHOD FOR AUTOMATICALLY LOCATING MICROSEISMIC EVENTS BASED ON DEEP BELIEF NEURAL NETWORK AND COHERENCE SCANNING

(71) Applicant: China University of Mining and Technology, Beijing, Beijing (CN)

(72) Inventors: Jing ZHENG, Beijing (CN); Tianqi JIANG, Beijing (CN); Suping PENG, Beijing (CN)

(21) Appl. No.: 16/204,056

(22) Filed: Nov. 29, 2018

(30) Foreign Application Priority Data
Oct. 16, 2018 (CN) 201811204925.2

(51) Int. Cl. G01V 1/28; G01V 1/18; G01V 1/36; G06N 3/04; G06N 3/08

(52) U.S. Cl. CPC G01V 1/288; G01V 1/181; G01V 2210/41; G06N 3/0472; G06N 3/088; G01V 1/364

(57) ABSTRACT

A method for automatically locating microseismic events based on a deep belief neural network and coherence scanning includes the following steps: randomly selecting data of one three-component geophone; performing arrival time picking and phase identification of microseismic events on the data thereof using a deep belief neural network; and then, on the basis of the obtained arrival time and phases, performing coherence scanning and positioning imaging using the microseismic data received by all three-component geophones. In the image, the space position representing the highest stacking energy may be considered as a real space position where the microseismic events occur, implementing the automatic and accurate locating of the microseismic events.

### CROSS-REFERENCE TO RELATED APPLICATIONS

This application claims the benefit of priority from Chinese Application No. 201811204925.2, filed on Oct. 16, 2018. The content of the aforementioned application, including any intervening amendments thereto, is incorporated herein by reference.

### TECHNICAL FIELD

The present invention relates to the technical field of methods for locating microseismic events, and particularly relates to a method for automatically locating microseismic events based on a deep belief neural network and coherence scanning.

### BACKGROUND

In the process of exploiting resources and monitoring underground stress conditions, there is a need to monitor microseismic events to quantitatively describe fracture positions of underground mediums. As an important step of microseismic monitoring work, microseismic locations are not only related to the description of the space positions of hypocenters, but also have influence on the correct inversion and calculation of the microseismic source mechanism and magnitude, so that the accuracy of microseismic event location is of great importance to the microseismic monitoring work.

The Geiger theory-based microseismic locating algorithm is a simple and highly-efficient locating algorithm. The Geiger theory-based locating algorithm makes the objective function achieve global optimum based on the optimization theory by manually or automatically picking up the arrival time of a microseismic event from the hypocenter to a geophone, thus achieving the purpose of locating. However, the Geiger theory-based locating algorithm has the disadvantages in two aspects: first, the locating result is very sensitive to the pickup result of arrival time of the microseismic event, so that inaccurate pickup of arrival time may have influence on the locating result; the signal-to-noise ratio of microseismic data is not high in general, causing difficulties in accurate pickup of arrival time; and second, in the process of determining the global minimum of the objective function using the optimization algorithm, the algorithm usually converges to the local minimum, which may have influence on the accurate degree of the locating result as well. Therefore, when processing microseismic data of low signal-to-noise ratio, the Geiger theory-based algorithm often has a non-ideal effect.

The coherence scanning-based microseismic locating algorithm is another locating algorithm which is widely used. Different from the Geiger theory-based algorithm, the coherence scanning-based locating algorithm constructs a stacked energy image of amplitude using the travel time information of the microseismic events in the underground space and the signals obtained by geophones, wherein the space position having the highest energy in the image is considered as the real position where a seismic event occurs. The coherence scanning-based locating algorithm has the advantages that by using the amplitude information in the microseismic record, the algorithm has certain robustness to low signal-to-noise ratio data, and has certain tolerance to the travel time calculation errors of microseismic events. These advantages make the coherence scanning-based locating algorithm have better stability as compared with the Geiger-type locating algorithm. However, the coherence scanning-based locating algorithm also has the following disadvantages: first, the coherence scanning-based locating algorithm is required to perform grid partitioning on the monitoring area, and the origin time of microseismic events is unknown, so that the process of performing locating superposition imaging is a search process of a four dimensional space in fact (3D space and 1D time domain); and when the monitoring area is large and fine grid partitioning is required, it means huge amount of calculation, bringing challenges to real-time locating of the microseismic events; and second, the seismic records are related to multiple phases (such as P-waves or S-waves), and different velocity models of underground media are required by the different microseismic phases when coherence scanning is performed. Most of the existing coherence scanning-based locating algorithms require phase identification manually, so that the locating algorithm cannot perform automatic locating.

Therefore, the problem to be urgently solved by those skilled in the art is how to provide a method for automatically and accurately locating microseismic events.

### SUMMARY

In view of this, the present invention provides a method for automatically locating microseismic events based on a deep belief neural network and coherence scanning, which implements automatic and accurate locating of microseismic events.

To achieve the above purpose, the present invention adopts the following technical solution:

A method for automatically locating microseismic events based on a deep belief neural network and coherence scanning includes the following steps:

step 1: randomly selecting one three-component geophone in a monitoring area, to extract three-component seismic data thereof;

step 2: filtering the three-component seismic data extracted in the step 1 by a Gammatone filterbank to obtain output responses;

step 3: performing discrete cosine transform on the output responses obtained in the step 2, and obtaining GFCC features;

step 4: constructing a deep belief neural network using restricted Boltzmann machines, and obtaining parameters of the deep belief neural network by training data;

step 5: taking the GFCC features obtained in the step 3 as input layer data of the deep belief neural network, the output layer result thereof including the microseismic phases and arrival time in the three-component seismic data in the step 1;

step 6: discretizing the space position of the monitoring area into i×j×k three-dimensional space grid points;

step 7: for the data (seismic traces) collected by all the three-component geophones, selecting a time windows with length of N, and sliding the time window according to the seismic wave travel time from each grid point to each geophone in the step 6, and the arrival phases and arrival time picked up in the step 5, wherein the theoretical seismic wave travel time includes P wave travel time and S wave travel time; and step 8: performing corresponding semblance coefficient calculation on each space grid point according to the amplitude information acquired by sliding the time window in the step 7, and then obtaining an energy stacking data volume of coherence scanning, wherein the space position of a grid point corresponding to the maximum semblance coefficient is the real position where a microseismic event occurs.

Preferably, in the step 2, the pulse response expression of the Gammatone filters is:

g(f,t)=atⁿ⁻¹e^{-2nbt}cos(2nft+φ)

where α represents gain coefficient, t represents time, n represents filter order, b represents attenuation coefficient, φ represents phase, and f represents center frequency.

Preferably, in the step 2, the output response obtained by filtering the three-component seismic data by a Gammatone filterbank is Gₘ^{α}(i)=g_{d}^{α}(i,m)^{1/3},

where g_{d}^{α} represents a result obtained by downsampling after a component seismic data are filtered by the Gammatone filters, and subscript d represents downsampling; and i=0,1,2, . . . , N−1 represents the number of the Gammatone filters, and m=0,1,2, . . . M−1 represents the frame number after framing seismic signals.

Preferably, in the step 3, the expression of calculation of the GFCC features is:

$${C}_{m}^{α} ( j ) = \sqrt{\frac{2}{N}} {\sum }_{i = 0}^{N - 1} {G}_{m}^{α} ( i ) cos ( \frac{j π}{2 N} ( 2 i + 1 ) ) ( α = x , y , z ; j = 1 , 2 , … N - 1 )$$

where Cₘ^{α}(j) represents the GFCC features corresponding to the α component seismic signal received by the j^{th} filter in the m^{th} frame, j=0,1, . . . , N−1 represents the number of filters, and m represents the frame number.

Preferably, in the step 8, corresponding semblance coefficient calculation is performed on each space grid point according to the amplitude information acquired by sliding the time window in the step 7, and then an energy stacking data volume of coherence scanning is obtained, the specific calculation formula being:

$$F ( i , j , k ) = {\sum }_{α = x , y , z} \frac{{( {\sum }_{R = 1}^{{N}_{R}} {\sum }_{L = 1}^{{N}_{L}} {S}_{α}^{R} [ \frac{{t}_{β}}{Δ t} - ( {τ}_{ref , R}^{β} ( i , j , k ) ) \text{/} Δ t - L ] )}^{2}}{{N}_{R} \times {\sum }_{R = 1}^{{N}_{R}} {\sum }_{L = 1}^{{N}_{L}} {( {S}_{α}^{R} [ \frac{{t}_{β}}{Δ t} - ( {τ}_{ref , R}^{β} ( i , j , k ) ) \text{/} Δ t - L ] )}^{2}} ( α = x , y , z ; β = P , S )$$

where τ_{ref,R}^{β}(i,j,k) represents the theoretical seismic e wave travel time difference from the space position corresponding to space grid points (i,j,k) in the step 6 to two geophone positions ref and R respectively, where ref represents the geophone randomly selected in the step 1,R represents the R^{th} geophone in the monitoring area; t_{β} represents the arrival time picked up in the step 5, and β represents microseismic phase, where longitudinal wave is P wave, and transverse wave is S wave; Δt represents sampling interval, N_{R} represents number of geophones, N_{L} represents the length of the time window, and L represents the serial number of the data sampling points included in the time window; and S_{α}^{R}(.) represents the α component microseismic signal received by R^{th} geophone in the monitoring area, and the corresponding numerical value in the bracket represents the serial number corresponding to the microseismic data sampling points.

It can be known from the technical solution that compared with the prior art, the present invention discloses a method for automatically locating microseismic events based on a deep belief neural network and coherence scanning, including the following steps: randomly selecting data of one three-component geophone, performing arrival time picking and phase identification of microseismic events on the data thereof using a deep belief neural network; and then, on the basis of the obtained arrival time and phase, performing coherence scanning and positioning imaging using the microseismic data received by all three-component geophones. In the image, the space position representing the highest stacked energy may be considered as a real space position where the microseismic events occur.

### BRIEF DESCRIPTION OF THE DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a flow chart of a method for automatically positioning microseismic events based on a deep belief neural network and coherence scanning provided by the present invention;

FIG. 2 is schematic diagram of geophone arrays installed in the monitoring area provided by the present invention;

FIG. 3 is a diagram of microseismic signals received by geophones provided by the present invention;

FIG. 4a is a diagram of a microseismic arrival picking results provided by the present invention;

FIG. 4b is a diagram of a microseismic event phase identification of a randomly extracted track (reference trace);

FIG. 5 is a diagram of coherence scanning locating result provided by the present invention;

FIG. 6 is a diagram of slices of a stacking image at a position 1500 meters in depth provided by the present invention; and

FIG. 7 is a structural diagram of a DBN model provided by the present invention.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

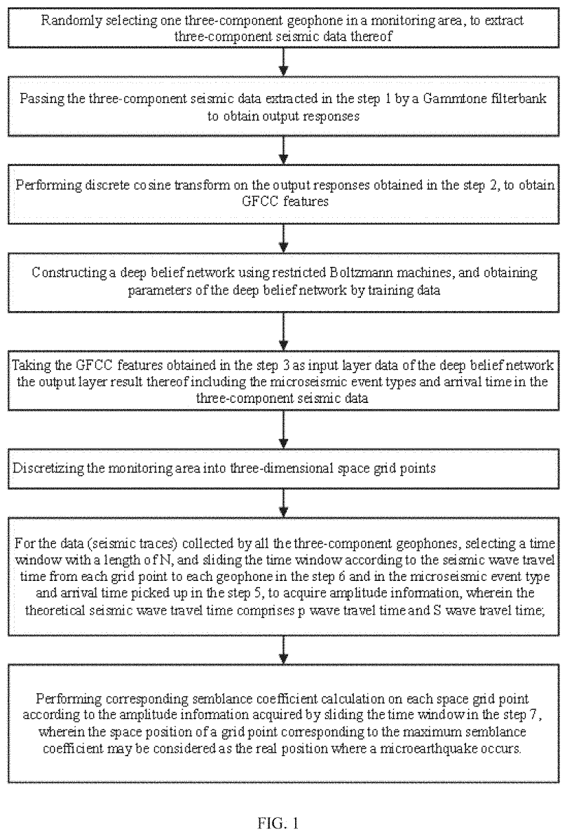

See FIG. 1. Embodiments of the present invention disclose a method for automatically locating microseismic events based on a deep belief neural network and coherence scanning, specifically including the following steps:

Step 1: Randomly selecting one three-component geophone in a monitoring area, to extract three-component seismic data thereof, the three-component seismic data being specifically expressed as Sₓ(i), S_{y}(i), S_{z}(i) and i=1,2, . . . , N, and N being the number of sampling points of data.

Step 2: Filtering the three-component seismic data Sₓ(i), S_{y}(i) and S_{z}(i) extracted in the step 1 by a Gammatone filterbank to obtain output responses Gₓ, G_{y} and G_{z}. In the step 2, the pulse response expression of the Gammatone filters is:

g(f,t)=atⁿ⁻¹e^{-2nbt}cos(2nft+φ)

where α represents gain coefficient, t represents time, n represents filter order, b represents attenuation coefficient, φ represents phase, and f represents center frequency.

Step 3: Performing discrete cosine transform (DCT) on the output responses Gₓ, G_{y} and G_{z} obtained by filtering the three-component seismic data by Gammatone filters in the step 2, and obtaining GFCC features, wherein the specific expression of the GFCC is:

$${C}_{m}^{α} ( j ) = \sqrt{\frac{2}{N}} {\sum }_{i = 0}^{N - 1} {G}_{m}^{α} ( i ) cos ( \frac{j π}{2 N} ( 2 i + 1 ) ) ( α = x , y , z ; j = 1 , 2 , … N - 1 )$$

where Cₘ^{α}(j) represents the GFCC features corresponding to the α component microseismic signal received by the j^{th} filter in the m^{th} frame, j=0,1, . . . , N−1 represents the number of filters, and m represents the frame number.

Step 4: Constructing a deep belief neural network using restricted Boltzmann machines, and obtaining parameters of the deep belief neural network by training data.

Step 5: Taking the GFCC features obtained in the step 3 as input layer data of the deep belief neural network, the output layer result including the microseismic phases and arrival time in the three-component seismic data in the step 1, and respectively recording the P wave arrival time and S wave arrival time as tₚ and tₛ.

All the above steps implement the automatic arrival time picking and phase identification of microseismic events. This part will be further described as below.

The aim of a method for automatically arrival picking is to recognize signals of the microseismic events from mixed signals (including background noise), and mainly includes two phases. The first phase is a “feature extraction” phase. In this phase, the mixed signals are transformed by a certain transformation method, and the transformed signals are used to train and test the deep belief neural network. The second phase is used to classify the microseismic events and noise in the signals by a DBN-based classifier. The input of this classifier is a data feature of the first phase after “feature extraction”.

The implementation process of the first part is as follows: by taking into account of the similarity between an audio signal and a microseismic signal, a GFCC feature is selected as a robustness feature of the microseismic signal. To obtain a GFCC feature vector, the microseismic signal is filtered by a filter bank composed of Gammatone filters first, an auditory spectrum of the seismic signal is obtained, and then discrete cosine transform (DCT) is performed on the auditory spectrum to obtain the GFCC feature vector.

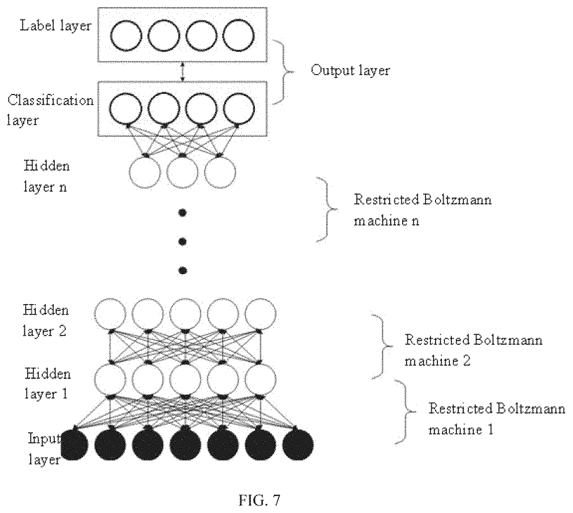

The implementation process of the second part is as follows: A deep belief neural network is constructed to implement automatic detection of microseismic events. The process of constructing the network is divided into two phases, i.e. a training phase and a testing phase. In the training phase, the main process is to establish a mathematical model of the network using training data which may be GFCC feature of microseismic data obtained through numerical simulation and may be GFCC feature of the field data as well, and the mathematical model of the network is obtained by iteration, to complete the step 4. In the testing phase, the main process is to recognize microseismic events through the trained network model using testing data which refer to the GFCC feature of data used for locating microseismic events, to complete the step 5. FIG. 7 shows a graph model of a deep belief neural network (DBN), the DBN model is a layer-shaped model, the lowermost layer is an input layer, the uppermost layer is an output layer, and the intermediate layer is called hidden layer. The output layer of the DBN is a classification process used to classify inputs of the DBN. One restricted Boltzmann machine is formed by two adjacent layers, wherein the lower layer is a visual layer, and the upper layer is a hidden layer, a DBN is constructed by stacking restricted Boltzmann machines (RBMs), and a classification layer is connected behind the hidden layer of the uppermost restricted Boltzmann machine. The learning process of the RBM during the training phase is unsupervised in fact, so that there is no need for the traditional DBN to make classification labels for the microseismic data. In the process of network training, to make the performance of the DBN more excellent, a fine-tune process is added into the DBN. To implement the fine-tune process, a label layer is added to the output layer of the DBN (see FIG. 7). This label layer includes information for manually making microseismic data of a training data set, i.e. making classification labels, including arrival time of microseismic events and phase of the events. In the network training phase, the parameters of the network model are initialized by the RBM, and the input data are classified by a multinomial logistic regression layer, i.e. a classification layer. The label layer is used to evaluate the error between the predicted output and manual labeling (between the arrival time of microseismic events picked up manually and phase of the events). The optimization process making this error decrease is completed by a random gradient descent policy. When the error is less than a certain threshold, the fine-tune process is ended, and the network training is completed.

Step 6: Discretizing the space position of the monitoring area into i×j×k three-dimensional space grid points.

Step 7: For the data (seismic traces) collected by all the three-component geophones, selecting a time window with a length of N, and sliding the time window according to the seismic wave travel time from each grid point to each geophone in the step 6 and the microseismic phases and arrival time picked up in the step 5, to acquire amplitude information, wherein the theoretical seismic wave travel time includes P wave travel time and S wave travel time.

Step 8: Performing corresponding semblance coefficient calculation on each space grid point according to the amplitude information acquired by sliding the time window in the step 7, and then obtaining an energy stacking data volume of one scanning superposition, wherein the specific calculation formula thereof is:

$$F ( i , j , k ) = {\sum }_{α = x , y , z} \frac{{( {\sum }_{R = 1}^{{N}_{R}} {\sum }_{L = 1}^{{N}_{L}} {S}_{α}^{R} [ \frac{{t}_{β}}{Δ t} - ( {τ}_{ref , R}^{β} ( i , j , k ) ) \text{/} Δ t - L ] )}^{2}}{{N}_{R} \times {\sum }_{R = 1}^{{N}_{R}} {\sum }_{L = 1}^{{N}_{L}} {( {S}_{α}^{R} [ \frac{{t}_{β}}{Δ t} - ( {τ}_{ref , R}^{β} ( i , j , k ) ) \text{/} Δ t - L ] )}^{2}} ( α = x , y , z ; β = P , S )$$

where τ_{ref,R}^{β}(i,j,k) represents the theoretical seismic wave travel time difference from the space position corresponding to space grid points (i,j,k) in the step 6 to two geophone positions ref and R respectively, where ref represents the geophone randomly selected in the step 1,R represents the R^{th} geophone in the monitoring area; t_{β} represents the arrival time picked up in the step 5, and β represents microseismic phase, where longitudinal wave is P wave, and transverse wave is S wave; Δt represents sampling interval, N_{R} represents number of geophones, N_{L} represents the length of the time window, and L represents the serial number of the data sampling points included in the time window; and S_{α}^{R}(i) represents the α component microseismic signal received by the R^{th} geophone in the monitoring area, and the corresponding numerical value in the bracket represents the serial number corresponding to the sampling points of microseismic data, wherein the space position of a grid point corresponding to the maximum semblance coefficient in F (i,j,k) may be considered as the real position where microseismic events occur.

The present invention proposes a method for automatically locating microseismic events based on a deep belief neural network and coherence scanning. In this method, seismic data of three-component geophones are used to perform locating. The locating method mainly includes two parts: first, randomly selecting three-component data collected by one geophone, picking up microseismic events in a microseismic record through a deep belief-based neural network, and judging microseismic phases (P wave, S wave). By means of arrival time picked up from this three-component data, the problem that the amount of calculation is large due to the fact that the time when the microseismic event occurs is unknown is solved; and by means of the picked up seismic event phases (P wave, S wave), which velocity model (S wave, P wave) may be selected during next coherence scanning may be guided, so that the positioning algorithm may implement automatic positioning. The second part includes: constructing an amplitude energy stacking image using coherence scanning. There is a need to perform grid partitioning on the monitoring space to obtain corresponding grid points, and for each grid point, corresponding amplitude stacking energy is calculated using the microseismic arrival time and microseismic phase obtained in the first part. In the present invention, semblance coefficients are used to calculate amplitude stacking energy, and an amplitude energy superposition image is formed by calculating an amplitude energy superposition value corresponding to each grid point in the monitoring area. The space position representing the highest stacking energy may be considered as a real space position where the microseismic events occur.

The technical solution of the present invention will be further described in detail below in combination with the experiment simulation results.

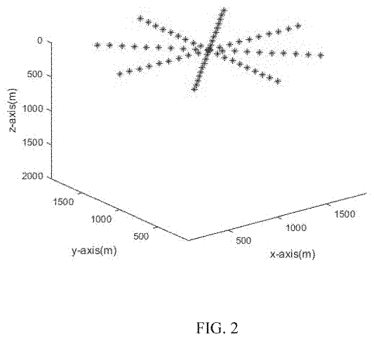

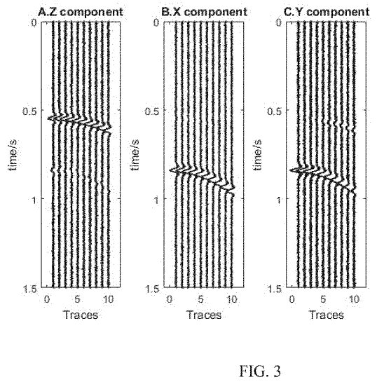

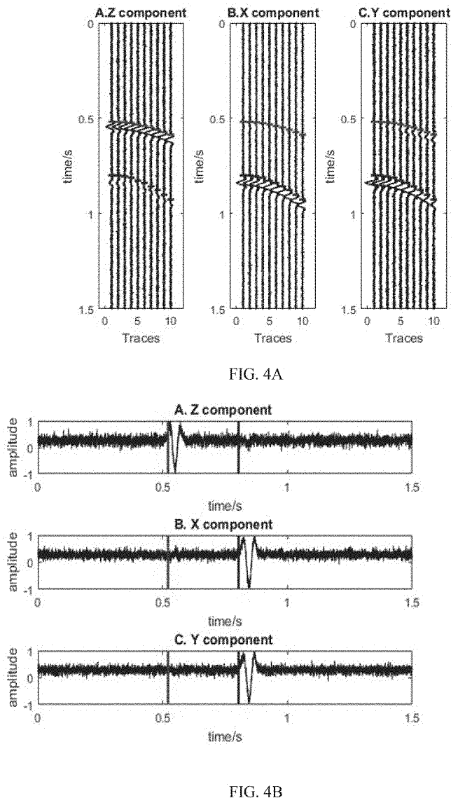

A microseismic monitoring area is established, it is assumed that the size of this three-dimensional monitoring area is 2000m*2000m*2000m, the geophones are arranged on the earth's surface, and the orientations of the monitoring area and the three-component geophones are as shown in FIG. 2. Red “*” identifiers represent geophones. The medium in the monitoring area is uniform, the medium speed is as follows: longitudinal wave (P wave) velocity: 3600 m/s, transverse wave speed: 2120 m/s, and a seismic wave theory travel time query table is established on this account. One microseismic event is set at the position (800, 900, 1500) m away from the monitoring area, and signals received by the geophones are as shown in FIG. 3. Three-component data collected by one geophone is randomly selected from the received microseismic signal data as reference data, recognition is performed using the microseismic event recognition method proposed in the present invention, and the result is as shown in FIG. 4. By means of the pickup method, not only seismic events may be accurately picked up, but also the types of seismic signals may be judged. In FIG. 4, the red solid line represents the arrival time of longitudinal wave (P wave), and the blue solid line represents the arrival time of transverse wave (S wave).

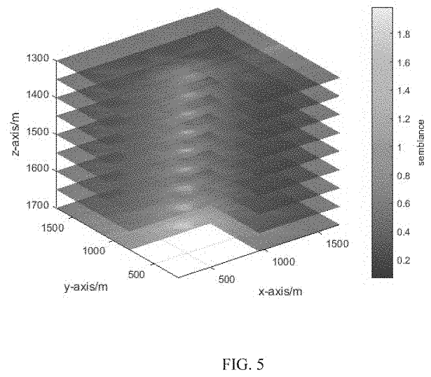

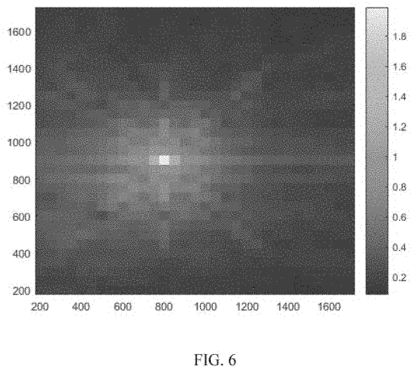

According to the information provided by the microseismic recognition method, in combination seismic data collected by all geophones and the made theoretical travel time query table, coherence scanning is performed to obtain a locating result, and a locating image is as shown in FIG. 5. It can be seen from the FIG. 5 that energy is focused in the vicinity of a position (800, 900, 1500) m away from the real hypocenter, the position where the stacking energy is the maximum is at the position of (800, 900, 1500) m, FIG. 6 shows energy stacking slices at the position of 1500m in depth, and the position where energy is the maximum is the real hypocenter position, which illustrates that the automatic locating method proposed by the present invention is accurate and valid.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein. Therefore, the present invention will not be limited to these embodiments shown herein, but will conform to the widest scope consistent with the principle and novel features disclosed herein.

What is claimed is:

1. A method for automatically locating microseismic events based on a deep belief neural network and coherence scanning, wherein the method comprises the following steps:
step 1: randomly selecting one three-component geophone in a monitoring area, to extract three-component seismic data thereof;
step 2: filtering the three-component seismic data extracted in the step 1 by a Gammatone filterbank to obtain output responses;
step 3: performing discrete cosine transform on the output responses obtained in the step 2; and obtaining GFCC features;
step 4: constructing a deep belief neural network using restricted Boltzmann machines; and obtaining parameters of the deep belief neural network by training data;
step 5: taking the GFCC features obtained in the step 3 as input layer data of the deep belief neural network; the output layer result thereof comprising the microseismic phases and arrival time in the three-component seismic data;
step 6: discretizing a space position of the monitoring area into i×j×k three-dimensional space grid points;
step 7: for the data (seismic traces) collected by all the three-component geophones, selecting a time window with a length of N; and sliding the time window according to the theoretical seismic wave travel time from each grid point to each geophone in the step 6 and the microseismic phases and arrival time picked up in the step 5 to acquire amplitude information; wherein the theoretical seismic wave travel time comprises P wave travel time and S wave travel time; and
step 8: performing corresponding semblance coefficient calculation on each space grid point according to the amplitude information acquired by sliding the time window in the step 7; and then obtaining an energy stacking data volume of one coherence scanning; wherein the space position of a grid point corresponding to the maximum semblance coefficient is the real position where a microseismic event occurs.

2. The method for automatically locating microseismic events based on a deep belief neural network and coherence scanning of claim 1, wherein in the step 2, the pulse response expression of the Gammatone filters is:
g(f,t)=atⁿ⁻¹e^{-2nft}cos(2nft+φ)
where α represents gain coefficient; t represents time; n represents filter order; b represents attenuation coefficient; φ represents phase; and f represents center frequency.

3. The method for automatically locating microseismic events based on a deep belief neural network and coherence scanning of claim 1, wherein in the step 2, the output response obtained by filtering the three-component seismic data by a Gammatone filterbank is Gₘ^{α}(i)=|g_{d}^{α}(i,m)|^{1/3},
where g_{d}^{α} represents a result obtained by downsampling after a component seismic data are filtered by the Gammatone filters; and subscript d represents downsampling; and i=0,1,2, . . . , N−1 represents the number of the Gammatone filters; and m=0,1,2, . . . M−1 represents the frame number after framing seismic signals.

4. The method for automatically locating microseismic events based on a deep belief neural network and coherence scanning of claim 1, wherein in the step 3, the expression of calculation of the GFCC features is:
$${C}_{m}^{α} ( j ) = \sqrt{\frac{2}{N}} {\sum }_{i = 0}^{N - 1} {G}_{m}^{α} ( i ) cos ( \frac{j π}{2 N} ( 2 i + 1 ) ) ( α = x , y , z ; j = 1 , 2 , … N - 1 )$$
where Cₘ^{α}(j) represents the GFCC features corresponding to the α component microseismic signal received by the j^{th} filter in the m^{th} frame; j=0,1, . . . , N−1 represents the number of filters; and m represents the frame number.

5. The method for automatically locating microseismic events based on a deep belief neural network and coherence scanning of claim 1, wherein in the step 8, corresponding semblance coefficient calculation is performed on each space grid point according to the amplitude information acquired by sliding the time window in the step 7; and then an energy stacking data volume of one coherence scanning is obtained, the specific calculation formula being:
$$F ( i , j , k ) = {\sum }_{α = x , y , z} \frac{{( {\sum }_{R = 1}^{{N}_{R}} {\sum }_{L = 1}^{{N}_{L}} {S}_{α}^{R} [ \frac{{t}_{β}}{Δ t} - ( {τ}_{ref , R}^{β} ) \text{/} Δ t - L ] )}^{2}}{{N}_{R} \times {\sum }_{R = 1}^{{N}_{R}} {\sum }_{L = 1}^{{N}_{L}} {( {S}_{α}^{R} [ \frac{{t}_{β}}{Δ t} - ( {τ}_{ref , R}^{β} ) \text{/} Δ t - L ] )}^{2}} ( α = x , y , z ; β = P , S )$$
where τ_{ref,R}^{β} represents the theoretical seismic wave travel time difference from the space position corresponding to space grid points (i,j,k) in the step 6 to two geophone positions ref and R respectively; where ref represents the geophone randomly selected in the step 1;R represents the R^{th} geophone in the monitoring area; t_{β} represents the arrival time picked up in the step 5; and β represents microseismic phase; where longitudinal wave is P wave, and transverse wave is S wave; Δt represents sampling interval; N_{R} represents the number of geophones; N_{L} represents the length of the time window; and L represents the serial number of the data sampling points included in the time window; and S_{α}^{R}(i) represents the α component microseismic signal received by the R^{th} geophone in the monitoring area; and the corresponding numerical value in the bracket represents the serial number corresponding to the microseismic data sampling points.
